(19) United States
(12) Patent Application Publication
(10) Pub. No.: US 2005/0236550 A1
(43) Pub. Date: Oct. 27, 2005

(54) Self-adjusting support for moulds and dies

(76) Inventor: Jon Unai Cobeaga Arruti, Gauteriz De Arteaga, Vizcaya (ES)

Correspondence Address: KATTEN MUCHIN ROSENMAN LLP, 575 MADISON AVENUE, NEW YORK, NY, 10022-2585, US

(21) Appl. No.: 10/515,905

(22) PCT Filed: Apr. 29, 2003
(86) PCT No.: PCT/ES03/00187

§ 371 Date: Nov. 24, 2004

(30) Foreign Application Priority Data
May 27, 2002 (ES) U200201416

(51) Int. Cl. F16M 11/00

(52) U.S. Cl. 248/694

(57) ABSTRACT

Self-adjusting support for moulds, dies and other pieces intended for installation on a variety of machines which is self-adjusting with no need for tools, nor replacement, nor changing of parts, and which is made up of a cylindrical base body (1) provided with a recess (7) in a central longitudinal direction which is extended towards the upper end by way of a through-hole (8) for inserting and positioning a pin bolt (3) on which is mounted a washer (2) secured by means of a retaining nut (6) threaded onto the protruding end of said pin bolt (3), the lower end of which presents a head (9) that is located in the cavity (7), with the special feature that a spring (4) is positioned between the head of the pin bolt (3) and the bottom of the cavity (7) and another spring (5) is fitted between the washer (2 ) and the upper portion of the base body (1).

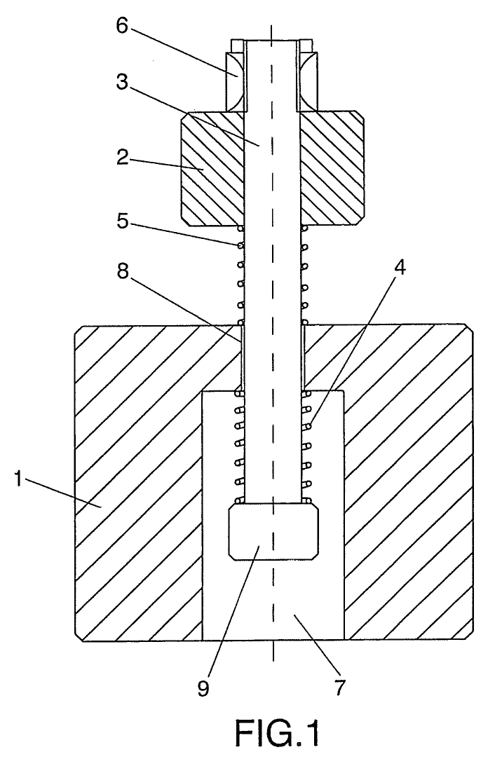

### OBJECT OF THE INVENTION

The present invention refers to a self-adjusting support for moulds, dies and other parts intended to be installed on a variety of machines, whether for their construction, mechanisation, repair or for their use.

The object of the invention is to provide the die-making sector and other fields of application with a support for the afore-mentioned type of pieces which is self-adjusting without the need for tools or replacement of components, determining a means that is coupled to the die, mould or piece in question, forming with this a single assembly that not only facilitates the support of pieces of this type, but also their handling, transport, storage, etc.

### BACKGROUND OF THE INVENTION

The moulds, dies and similar types of pieces which are installed on a variety of machines, whether for their construction, mechanisation, repair or for their use on different machines, for handling, storage or transport purposes are arranged on supports that are usually formed of blocks of wood, or else wooden pallets or similar elements, all this for the purpose of preventing the contact of the sensitive parts of these dies, moulds or pieces with the floor, and thereby to save damage to the pieces or even to the actual floor.

The drawback inherent in these supports formed of wooden blocks, pallets, etc, is that the mould, die or piece is loaded on the support without any connection being established between them, so the mould or die may be moved in respect of the support, so that they are unstable in their storage or transport.

Sometimes the support and the mould or die are fastened together with nuts and bolts or steel strapping. This solution overcomes the problem of mobility and therefore the stability of the die or mould on the support, although it has the drawback of having to resort to tools for bolting or strapping both pieces together, which makes installation more complicated.

### DESCRIPTION OF THE INVENTION

The self-adjusting support for moulds and dies of the invention resolves the above-mentioned problems on the basis of a simple but highly effective solution, being conceived and designed taking into account that dies, moulds and similar pieces have a certain weight and size and are provided with anchoring channels and grooves for their attachment to such machine tools as injectors, presses, etc, in such a way that the support of the invention makes use of these channels or grooves in the dies, moulds or pieces for their coupling to the die or mould so that they form a single assembly that prevents mobility between both pieces, and what is even more important, without having to carry out any bolting or strapping operations.

More specifically, the self-adjusting support made up of a body consisting of a base which acts as the support and protection for the die, mould or piece and which may be made of nylon, plastic or any other hard-wearing material that is not damaged by the weight, with the special feature that said body or base is provided with an axial cavity which accommodates the head of a pin bolt that passes through a hole concentric with the cavity and with the actual base body, the end of said pin bolt protruding to the exterior in order to situate, adjacent to that end, a washer that is secured by means of a nut fitted on the actual end of the pin bolt.

Between the inner head, which is housed in the cavity of the base body, and the bottom of said cavity a spring, which tends to bring the washer at the protruding end closer to the base body, is disposed concentrically with the respective section of the pin bolt, while a second spring interposed between this washer and the base body keeps the aforesaid washer separated from the base body, it being by way of this section of the pin bolt on which the second spring is located that the support will be attached to the channel anchoring the die, mould or piece in question, so that by virtue of the afore-mentioned springs it is possible to carry out the self-adjusting of the support to the piece to which it is attached, be it a mould, a die or some other similar piece.

Obviously, a greater or smaller extent of the section of the pin bolt corresponding to that defined between the washer and the base body will be achieved depending on the length of the springs, and it may thereby be adjusted to the different types or sizes of anchorage of the die, mould or piece on which it is applied.

In this way, a support is achieved that enables us to keep the die or mould separate from the floor and permit its raising by means of fork lift trucks or else assure the protection of that mould or die from rubbing, knocks, damp, etc.

Special mention should be made of the fact that one of the main advantages of the self-adjusting support is that it is easy to install in the anchor channels or grooves in the die or mould, which is achieved by means of the functional combination of the two springs which exert sufficient pressure so that it is held firmly against the upper and lower faces of the anchoring channel or groove in the die or mould.

### DESCRIPTION OF THE DRAWINGS

To supplement the description that is going to be given below and in order to assist a clearer understanding of the features of the invention, in accordance with a preferred example of a practical embodiment of same, the present descriptive report is accompanied by a set of drawings wherein for informative but never restrictive purposes we have represented a longitudinal sectional view of the self-adjusting support executed in accordance with the object of the invention, where all its structural features may be seen.

### PREFERRED EMBODIMENT OF THE INVENTION

In the light of the above-mentioned figure it may be observed that the self-adjusting support of the invention is composed of a preferably cylindrical configuration base body (1) that may be made of Nylon®, plastic or any other strong material that is not damaged by weight, said base body (1) being provided with a recess (7) in a central longitudinal direction, a recess (7) that occupies a considerable part of the height of the base body (1) and extends towards the upper end by way of a through-hole (8) for inserting and positioning a pin bolt (3) on the outside of which a washer (2) is disposed that is secured by means of a nut (6) threaded onto the outer protruding end of the pin bolt (3).

The lower end of this pin bolt (3), i.e. the one that is located in the cavity (7), presents a head (9) between which and the bottom of the cavity (7) a spring (4) is located, while a second spring (5) is positioned between the upper portion of the base body (1) and the washer (2).

In this way, the self-adjusting support is applied to the anchoring channel of, for example, a die, mould or similar piece, by positioning in the corresponding channel the section accommodating the spring (5), which permits the self-adjustment to be carried out due to the latter's elasticity and the actual elasticity of the inner spring (4), depending on the thickness or depth of the afore-mentioned anchoring channel in the die or mould, with the special feature that this spring (4) tends to press the pin bolt (3) down and therefore to bring the washer (2) up against the base body (1), thereby leaving the support firmly secured on the die or mould, with no need for self-tapping screws, with no need for pins or any other additional element, not even for tools for carrying out the attachment procedure.

The support will prove more versatile if the springs (4) and (5) are of a different length, although greater versatility is achieved when the position of both springs is changed as it enables a single support or assembly to be coupled to a wider range of anchoring channel or groove thicknesses in the dies or moulds, without the need to replace the parts forming it.

1. Self-adjusting support for moulds and dies, which, being applicable to moulds, dies or similar pieces of the type provided with anchoring channels or grooves on a machine, characterised in that it comprises a base body with an open cavity at one of its ends and extended at the other end in a through-hole by way of the base body housing a pin bolt provided with an end head that is positioned in the cavity in the base body, while the other end, protruding to the exterior, is supplemented with a washer and a retaining nut, threaded at the free end of said pin bolt, with the special feature that between the head of the pin bolt and the bottom of the cavity in the base body there is a spring fitted that exerts pressure on said pin bolt, so that the washer tends to come up against the base body, while another spring that tends to separate the washer is disposed between said washer and the upper portion of the base body, establishing a self-adjusting positioning area or section on the anchoring groove or channel in the die or mould in question, being attached thereto.
